(19) United States
(12) Patent Application Publication
(10) Pub. No.: US 2016/0365557 A1
(43) Pub. Date: Dec. 15, 2016

(54) HIGH PERFORMANCE, TEMPERATURE RESISTANT, PRINTABLE SEPARATOR

(71) Applicant: Palo Alto Research Center Incorporated, Palo Alto, CA (US)

(72) Inventors: RANJEET RAO, Redwood City, CA (US); CHANG-JUN BAE, Mountain View, CA (US); SCOTT E. SOLBERG, San Jose, CA (US)

(21) Appl. No.: 14/734,729

(22) Filed: Jun. 9, 2015

(51) Int. Cl. H01M 2/16; H01M 2/14; H01M 10/0525

(52) U.S. Cl. CPC H01M 2/166; H01M 10/0525; H01M 2/145

(57) ABSTRACT

An electrochemical separator film includes a polymer, and particles of a first inorganic material having a first particle size suspended in the polymer. An electrochemical cell structure, includes at least one electrode on a substrate, and a separator film residing on top of the electrode, wherein the separator film comprises a polymer, and particles of a first inorganic material having a first particle size suspended in the polymer. A method of manufacturing a separator film, includes combining a polymer with a solvent for the polymer to form a polymer solution, mixing particles of a first inorganic material with the polymer, the particles having a first particle size to produce a separator mixture, depositing the separator mixture onto a substrate, and drying the separator mixture until the solvent and non-solvent are no longer present forming the separator film.

### STATEMENT REGARDING FEDERALLY SPONSORED RESEARCH AND DEVELOPMENT

This invention was made with Government support under DE-AR0000324 (3754) awarded by ARPA-E. The Government has certain rights in this invention.

### TECHNICAL FIELD

This disclosure relates to electrochemical devices, more particularly to electrochemical separators.

### BACKGROUND

Electrochemical devices, such as fuel cells and batteries, convert chemical energy into electrical energy (and vice-versa). All electrochemical devices have a few components in common For instance, a lithium-ion battery consists of, at minimum, an anode, a cathode, an insulating separator that lies between the two, and an electrolyte that facilitates motion of ions. In some electrochemical devices, such as solid-state batteries, the electrolyte and the separator may be the same structure. The separator must electrically insulate the cathode and anode while being ionically conductive. The conduction paths for electrons and ions remain separated. Electrons follow a conduction path outside of the battery from current collectors attached to the anode and cathode. Ions travel between the anode and cathode through the separator.

If the separator has cracks or holes, this allows direct electrical contract between the electrodes creating a potentially dangerous short. For this reason, it is important that the battery is kept at temperatures below the maximum operating temperature of the separator. For example, a polyolefin separator such as those commonly used in industry is comprised of a mixture of polypropylene and polyethylene. At temperatures above approximately 130° C., such a separator begins to deform and shrink, increasing the potential for a short. Modern battery systems require substantial engineering investment to monitor and regulate the temperature within the battery pack. Separator technologies which can increase the maximum operating temperature can reduce the need for these systems and their resultant costs.

The current predominant separator technology for lithium-ion batteries typically involves some sort of nano-porous polymer film. For instance, one process uses a dry process by which they melt and then subsequently extrude a polyolefin resin, such as polyethylene or polypropylene, into a flat sheet. The process then anneals the film to create texture with crystalline domains, then stretches it to create micropores in the sheet. The annealing and texturizing processes ensure that the micropores have uniform size and distribution.

Alternatively, some manufacturers produce separators with a wet process. This process melts the polymer with another organic component, and after deposition a solvent extracts the secondary organic component. The removal of the secondary organic component leaves behind micropores that allow the ions and electrolyte to flow.

One approach to increase the high temperature performance of the separator adds some form of inorganic reinforcement that has a significantly higher melting point than the standard polymer. At high temperatures, when the polymer separator would normally shrink and create a battery short circuit, the presence of the particles prevents shrinkage, pin-holing and maintains a safe battery Typically, this involves dispersing the inorganic particles in a suspension of solvent and a binder polymer, then casting or coating the solution on top of a conventional separator. After drying or other processing, this results in a conventional polyolefin separator coated, often on both sides, with a very thin layer of inorganic particles and binder.

This approach does not allow for co-extrusion of the separator with the electrodes, or for printing of the separator in a simple, one-step printing process in batteries, fuel cells or other electrochemical devices.

### SUMMARY

One embodiment consists of an electrochemical separator film including a polymer, and particles of a first inorganic material having a first particle size suspended in the polymer.

Another embodiment consists of an electrochemical cell structure including at least one electrode on a substrate, and a separator film residing on top of the electrode, wherein the separator film comprises a polymer, and particles of a first inorganic material having a first particle size suspended in the polymer.

Another embodiment consists of a method of manufacturing a separator film that includes combining a polymer with a solvent for the polymer to form a polymer solution, mixing particles of a first inorganic material with the polymer, the particles having a first particle size to produce a separator mixture, depositing the separator mixture onto a substrate, and drying the separator mixture until the solvent and non-solvent are no longer present forming the separator film.

### BRIEF DESCRIPTION OF THE DRAWINGS

FIG. 1 shows a flowchart of one embodiment of a method of manufacturing a battery separator.

FIG. 2 shows an embodiment of a separator deposited on a substrate with an electrode.

FIG. 3 shows a graph of critical cracking thickness as a function of formulation.

### DETAILED DESCRIPTION OF THE EMBODIMENTS

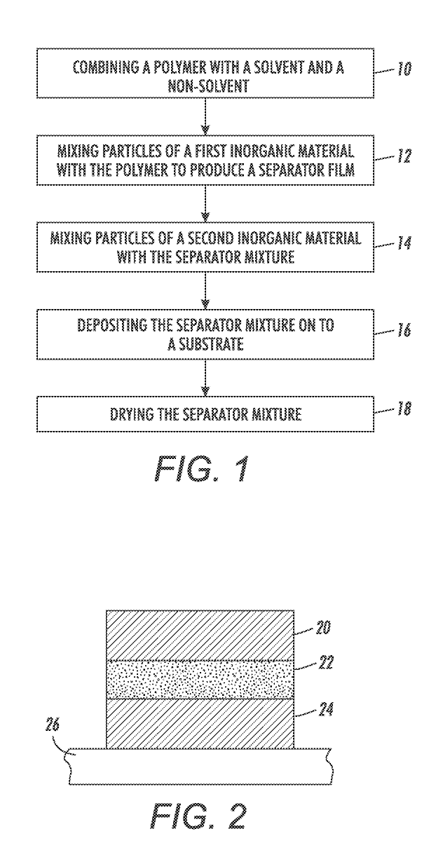

FIG. 1 shows a flowchart of one embodiment of a method of manufacturing a battery separator. At 10, a polymer is mixed with a solvent. This thins the polymer to allow it to be deposited using an extrusion or other type of print head. In one embodiment, the polymer is mixed with a solvent for the polymer, and a non-solvent for the polymer. One should note that the term solvent and non-solvent are in terms relative to the polymer. A material that may otherwise be characterized as a solvent, is not a solvent for this discussion unless it dissolves the polymer being used. The non-solvent may be optional, depending upon the polymer used. In addition, the non-solvent may be added later in the process, FIG. 1 shows one embodiment, with the understanding that many variations are included in the scope of the claims.

In an embodiment, the polymer was dissolved in the solvent and deposited on a substrate and allowed to dry. In one embodiment, the polymer is polyvinylidene fluoride (PVDF) and the solvent is N-methyl pyrrolidone (NMP), a non-aqueous solvent. Typically, this may not form an ideal form, as the film may warp and curl as it dries.

At 12, the process mixes particles of an inorganic material to the polymer/solvent solution. This may decrease the warping, but the addition of the particles to the solution may result in the film cracking upon drying. The maximum amount of particles one can add before cracking depends upon a number of factors, such as particle size and specific surface area. For example, the smaller the particle size, the lower the maximum loading before cracking occurs. Smaller particles also result in smaller pore sizes in the film, a generally desirable result. In one embodiment, a weight ratio of 1.75:1 polymer:particle and an overall particle volume fraction of less than 15% resulted in crack-free films for film thicknesses of less than 25 microns.

The selection of the particles may affect the performance of the film as a separator. The film must provide electrical insulation, be ionically conductive, and allow for good charge and discharge performance The wrong types of particles added to the suspension will cause the separator to perform poorly in that the assembled cell does not charge. One embodiment employs hydrophobic silica particles. The hydrophobic silica particles consist of fumed silica particles with a very high surface area and a special silanized coating to render them hydrophobic. Fumed silica generally consists of nanometer sized silicon dioxide particles that aggregate to form large branched structures.

While this combination of polymer and nanometer-sized inorganic particles forms a standalone separator film, issues may arise when co-deposited with another formulation used for battery electrodes, such as cathodes and anodes. When the separator film resides adjacent to an electrode film, such as top of an electrode film, it may promote cracking when the formulation dries. This may result from the differential shrinkage rates between the two formulations.

In one embodiment, which may work for a co-deposited formulation, at 14 a second inorganic material having a particle size larger than the particles of the first inorganic material are added. The amount of larger particles added needs to be controlled. Too few particles have no effect, too many particles result in poor function as a separator. In one embodiment, a ratio of 80:20 by weight of first inorganic material:second inorganic material improved the drying behavior and still allowed for acceptable separator performance In one embodiment, the materials consist of the fumed silica particles described above, and a large particle silica, wherein the large particle silica has a particle sized in the micrometer range. The separator mixture is co-deposited with a first electrode, which resides on a substrate.

As mentioned briefly above, changing the solvent system to a combination solvent and non-solvent may increase the co-deposited drying behavior at 18. In one embodiment, the NMP solvent above is combined with diethyl adipate (DEA), a high-boiling point ester that is a non-solvent for PVDF. The non-solvent has a higher boing point than the solvent. The solvent may have a boiling point of at least 100° C. In one embodiment, the ratio of solvent to non-solvent is approximately 85:15 by weight, making a solvent rich mixture. During drying, the solvent may evaporate at a greater rate compared to the non-solvent concentration, causing the polymer to precipitate out of the solution. In one embodiment, the ink formulation consists of 15.9 wt % PVDF, 7.3 wt % fumed silica, 1.8 wt % hydrophobic silica, 11.3 wt % DEA, and 63.7 wt % N-methyl pyrrolidone. More generally, the ink formulation may be stated as 15.9 wt % polymer, 7.3 wt % smaller particle inorganic material, 1.8 wt % larger particle inorganic material, 11.3 wt % non-solvent, and 63.7 wt % solvent. As mentioned above, the non-solvent may also be added with the inorganic particles, rather than with the polymer.

FIG. 2 shows a resulting battery structure, having electrodes 20 and 24 separated by the separator 22. The structure resides on a substrate, 26, and will typically be deposited using a co-extrusion print head that may allow all three materials to be deposited simultaneously. Further, the separator film may be deposited to completely cover the ‘bottom’ electrode to ensure complete separation between the anode and cathode.

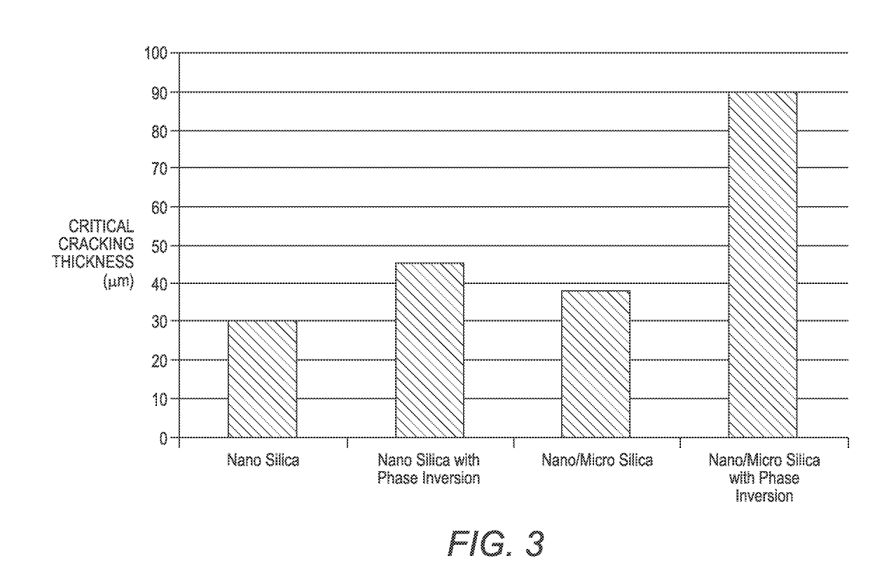

FIG. 3 shows a graph of the critical cracking thickness as a function of the formula. The critical cracking thickness is the maximum thickness that can be deposited without drying-stress induced cracking. FIG. 3 shows that using a formulation that incorporates both nano- and micro-sized particles as well as a ‘phase-inversion’ solvent blend comprised of solvent and a non-solvent, results in a maximum in critical cracking thickness being reached.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An electrochemical separator film, comprising:
a polymer; and
particles of a first inorganic material having a first particle size suspended in the polymer.

2. The electrochemical separator film of claim 1 further comprising particles of a second inorganic material having a second particle size suspended in the polymer, wherein the second particle size is larger than the first particle size

3. The electrochemical separator film of claim 1, wherein the polymer comprises polyvinylidene fluoride (PVDF).

4. The electrochemical separator film of claim 1, wherein the first inorganic material comprises a weight ratio of polymer to particles of 1.75:1.

5. The electrochemical separator film of claim 1, wherein the first inorganic material has an overall particle volume of less than 15%.

6. The electrochemical separator film of claim 1, wherein the first inorganic material comprises hydrophobic silica particles.

7. The electrochemical separator film of claim 5, wherein the silica particles comprise fumed silica particles of nanometer-sized silicon dioxide particles.

8. The electrochemical separator film of claim 1, wherein the second inorganic material comprises micrometer sized particles.

9. The electrochemical separator film of claim 1, wherein the first inorganic material and the second inorganic material have a ratio of 80:20 by weight.

10. The electrochemical separator film of claim 1, wherein the electrochemical separator comprises a battery separator.

11. An electrochemical cell structure, comprising:
at least one electrode on a substrate; and
a separator film residing on top of the electrode, wherein the separator film comprises:
a polymer; and
particles of a first inorganic material having a first particle size suspended in the polymer.

12. The electrochemical cell structure of claim 11, further comprising a second electrode residing on top of the separator film along an opposite side of the separator film from the first electrode, wherein one electrode is a cathode and the other electrode is an anode.

13. The electrochemical structure of claim 11, wherein the separator film further comprises particles of a second inorganic material having a second particle size suspended in the polymer, wherein the second particle size is larger than the first particle size.

14. A method of manufacturing a separator film, comprising:
combining a polymer with a solvent for the polymer to form a polymer solution;
mixing particles of a first inorganic material with the polymer, the particles having a first particle size to produce a separator mixture;
depositing the separator mixture onto a substrate; and
drying the separator mixture until the solvent and non-solvent are no longer present forming the separator film.

15. The method of claim 14, further comprising mixing particles of a second inorganic material into the separator mixture, the particles of the second inorganic material having a second particle size.

16. The method of claim 14, wherein combining a polymer with the solvent includes combining a non-solvent for the polymer with the polymer and the solvent.

17. The method claim 14, wherein mixing particles of the first inorganic material with the polymer includes mixing a non-solvent for the polymer with the particles of the first inorganic material.

18. The method of claim 14, wherein the solvent comprises N-methyl pyrrolidone (NMP).

19. The method of claim 14, wherein the non-solvent diethyl adipate (DEA).

20. The method of claim 14, wherein the first inorganic material comprises hydrophobic silica particles.

21. The method of claim 14, wherein the hydrophobic silica particles comprise fumed silica particles with a hydrophobic surface coating.

22. The method of claim 15, wherein the second inorganic material comprises silica particles having the second particle size, where the second particle size is larger than the first particle size.

23. The method of claim 14, further comprising simultaneously depositing at least one electrode material adjacent to and in contact with the separator film.

24. The method of claim 14, wherein the solvent has a boiling point of at least 100° C.
